(19) United States
(12) Patent Application Publication
(10) Pub. No.: US 2010/0097824 A1
(43) Pub. Date: Apr. 22, 2010

(54) BACKLIGHT UNIT AND MEMBER

(75) Inventors: Yohei Funabashi, Saitama (JP); Yasumaro Toshima, Saitama (JP)

Correspondence Address: BACON & THOMAS, PLLC, 625 SLATERS LANE, FOURTH FLOOR, ALEXANDRIA, VA, 22314-1176, US

(73) Assignee: KIMOTO CO., LTD., Tokyo (JP)

(21) Appl. No.: 12/530,823

(22) PCT Filed: Mar. 19, 2008
(86) PCT No.: PCT/JP2008/055091

§ 371 Date: Sep. 11, 2009

(30) Foreign Application Priority Data
Mar. 22, 2007 (JP) 2007-074160

(51) Int. Cl. F21V 7/04; B32B 5/16; B32B 27/32

(52) U.S. Cl. 362/608; 428/327

(57) ABSTRACT

A direct type backlight unit 1 comprising a light source 13, a diffusing plate 14 disposed over the light source, and an optical member 15 disposed on the diffusing plate, or an edge light type backlight unit comprising a light conducting plate and an optical member disposed on the light conducting plate, wherein the surface of the optical member 15 contacting with the diffusing plate or the light conducting plate (henceforth referred to as optical element) is formed from a material containing a thermosetting resin and/or a thermoplastic resin, and polyethylene type wax particles having a mean particle diameter of 4 to 10 μm. The content of the polyethylene type wax particles is 0.20 to 0.50 part by weight based on 100 parts by weight of resin component of the resin layer. Even when a molded article comprising an amorphous olefin resin or a polycarbonate resin is used as the optical element, adhesion of the optical element and the optical member 15 contacting with it can be prevented, and generation of scratches on the optical element as the molded article by the optical member 15 can be reduced.

### TECHNICAL FIELD

The present invention relates to a member for reducing generation of scratches on a molded article comprising an amorphous olefin resin or a polycarbonate resin. In particular, it relates to an optical member used in a backlight unit, which has a diffusing plate or a light conducting plate comprising an amorphous olefin resin or a polycarbonate resin, and capable of reducing generation of scratches on the diffusing plate or the light conducting plate.

### BACKGROUND ART

Backlight units of liquid crystal displays and so forth include those of direct type in which a diffusing plate is disposed, over a light source, and those of edge light type in which a light source is disposed along at least one end of a light conducting plate. In such backlight units, an optical member such as a light diffusing film is laminated in order to increase brightness for the frontal direction provided by a diffusing plate or light conducting plate, or make a diffusion pattern in a light conducting plate invisible.

Further, on the surface of such an optical member to be contacted with a diffusing plate or a light conducting plate, unevenness is formed in order to prevent adhesion with the diffusing plate or the light conducting plate. Such an uneven surface is formed from a binder resin and a small amount of beads, and as the beads, acrylic beads etc. are generally used considering optical characteristics and light resistance (Patent document 1).

Since demands for thinner backlight units increases, amorphous olefin resins and polycarbonate resins have come to be used for diffusing plates and light conducting plates instead of acrylic resins in order to make the diffusing plates and light conducting plates thinner. Moreover, since amorphous olefin resins and polycarbonate resins show superior optical characteristics such as transparency and superior physical properties such as impact resistance and moisture resistance, molded articles comprising an amorphous olefin resin or a polycarbonate resin have also come to be used for members other than light conducting plate or diffusing plate.

However, when an optical member on which uneven surface is formed with acrylic beads or the like is laminated on a molded article comprising an amorphous olefin resin or a polycarbonate resin, there arises a problem that scratches are generated on portions of the molded article comprising such a resin contacting by convexes formed from the acrylic beads etc., since the acrylic beads are relatively hard.

Various means have been proposed to solve this problem. For example, Patent document 2 proposes an optical sheet comprising a base material and an optically functional layer provided on the base material, wherein fine concaves and convexes are formed by embossing on the back surface of the base material. Patent document 3 proposes a light diffusing sheet comprising a base material sheet and a light diffusing layer formed on the base material sheet, wherein a sticking prevention layer comprising an ionizing radiation curable resin containing beads or wax is formed on the back surface of the base material sheet.

However, demands for further thinner backlight units and elements thereof have come to be more eager in recent years, and an amorphous olefin resin or a polycarbonate resin showing improved flowability has come to be used for molding a thin article using an amorphous olefin resin or a polycarbonate resin. Molded articles formed from such a resin showing improved flowability are more likely to suffer from generation of scratches compared with those formed from the materials used so far, and it has become unable to reduce generation of scratches with conventional means for preventing generation of scratches.

Patent document 1: Japanese Patent Unexamined Publication (KOKAI) No. 2003-270410 (Related Art)
Patent document 2: Japanese Patent Unexamined Publication No. 2002-357706 (Related Art, Object to be Achieved by the Invention)
Patent document 3: Japanese Patent Unexamined Publication No. 2002-323609 (Claims)

### DISCLOSURE OF THE INVENTION

### Object to be Achieved by the Invention

Therefore, an object of the present invention is to effectively prevent adhesion of a molded article comprising a resin showing improved flowability and a member laminated thereon, and yet, reduce generation of scratches on the molded article by the laminated member.

### Means for Achieving the Object

In order to achieve the aforementioned object, there were conducted various researches concerning configuration of a resin layer constituting a surface of a member, which is laminated to a molded article, as a surface to be brought into contact with the molded article, in particular, combination of resin and microparticles for forming unevenness and content of the microparticles. As a result, it was found that if a thermosetting resin and/or a thermoplastic resin was used as the resin, and polyethylene wax of specific mean particle diameter was used at a specific content, adhesion of contacted molded article comprising a resin of high flowability could be prevented, and generation of scratches on the molded article could also be reduced, and thus the aforementioned object was achieved.

The backlight unit of the present invention is a backlight unit comprising a light source, an optical element for conducting or diffusing light disposed close to the light source, and an optical member disposed on the optical element, wherein the optical member has a resin layer formed from a material containing a thermosetting resin and/or a thermoplastic resin, and polyethylene wax particles on the side to be contacted with the optical element, the polyethylene wax particles have a mean particle diameter of 4 to 10 μm, and the content of the polyethylene wax particles is 0.20 to 0.50 part by weight based on 100 parts by weight of resin component of the resin layer.

The backlight unit of the present invention is, for example, a direct type backlight unit, and in this case, the optical element is a diffusing plate disposed over the light source. Alternatively, the backlight unit of the present invention is an edge light type backlight unit, and in this case, the optical element is a light conducting plate, and the light source is disposed along at least one end of the light conducting plate.

In the backlight unit of the present invention, a functional layer which imparts an optical characteristic is provided on a surface of the optical member opposite to the surface on which the resin layer is provided. The functional layer is, for example, a light diffusing layer. Further, in the backlight unit of the present invention, the diffusing plate or light conducting plate on which the optical member is laminated comprises, for example, an amorphous olefin resin or a polycarbonate resin.

The member of the present invention is a member to be laminated on a molded article comprising an amorphous olefin resin or a polycarbonate resin, wherein surface of the member to be contacted with the molded article is constituted by a resin layer formed from a material containing a thermosetting resin and/or a thermoplastic resin, and polyethylene wax particles having a mean particle diameter of 4 to 10 μm, and the content of the polyethylene wax particles is 0.20 to 0.50 part by weight based on 100 parts by weight of resin component of the resin layer.

The member of the present invention may have a functional layer. The functional layer is preferably a light diffusing layer.

The mean particle diameters referred to in the present invention were calculated from values measured by the Coulter counter method (weight distribution).

### EFFECT OF THE INVENTION

According to the present invention, there can be provided a backlight unit and a member, in which or with which adhesion of a molded article comprising an amorphous olefin resin or a polycarbonate resin and a member contacting with the molded article is prevented, and generation of scratches caused by the member on the molded article comprising an amorphous olefin resin or a polycarbonate resin is reduced.

### BEST MODE FOR CARRYING OUT THE INVENTION

Embodiments of the backlight unit of the present invention will be explained.

The first embodiment of the backlight unit of the present invention is shown in FIG. 1.

The backlight unit according to the first embodiment of the present invention is a direct type backlight unit 1 provided with, as basic elements, a light source 13, a diffusing plate 14 disposed over the light source for erasing pattern of the light source 13, and an optical member 15 disposed on the diffusing plate. In the embodiment shown in FIG. 1, the optical member 15 is a member showing specific optical characteristics, and a prism sheet 16 is disposed thereon for directing lights to the light projection direction. Further, a reflective film 12 for reflecting lights of the light source 13 to the light projection side of the backlight unit is disposed under the light source 13, and it is contained in a chassis 11 together with the light source 12.

This backlight unit is characterized in that a specific resin layer for preventing adhesion is formed on the surface of the optical member 15 on the side to be contacted with the diffusing plate 14.

Further, the second embodiment is shown in FIG. 2. The backlight unit according to the second embodiment of the present invention is an edge light type backlight unit 2 provided with, as basic elements, a light conducting plate 17, a light source 13 disposed along at least one end of the light conducting plate 17, and an optical member disposed on the light projecting surface and/or the surface opposite to the light projecting surface of the light conducting plate 17. The light conducting plate 17 is for conducting lights of the light source in the direction along the surface thereof. In the embodiment shown in FIG. 2, on the light projecting surface and the surface opposite to the light projecting surface of the light conducting plate 17, optical members 15 and 12 are provided, respectively. Further, on the optical member 15, a prism sheet 16 for directing lights to the light projection direction is disposed.

This backlight unit is characterized in that a specific resin layer for preventing adhesion is formed on the surfaces of the optical members 15 and 12 on the side to be brought into contact with the light conducting plate 17.

As the light source used for the backlight units shown in FIGS. 1 and 2, cold-cathode tube, LED, organic or inorganic EL, and so forth can be used, and the light source may be in, for example, a dot shape, a linear shape, or a U shape.

The diffusing plate 14 used for the backlight unit of FIG. 1 and the light conducting plate 17 used for the backlight unit of FIG. 2 can be formed from any of conventionally known materials. However, the present invention is especially effective when a molded article comprising an amorphous olefin resin or a polycarbonate resin is used for them. Although molded articles comprising these resins show superior characteristics including transparency, impact resistance, heat resistance, and dimensional stability, they also have characteristics that they are relatively soft, and more likely to suffer from scratches compared with conventional molded articles comprising an acrylic resin. In particular, when the diffusing plate or the light conducting plate comprising an amorphous olefin resin or a polycarbonate resin has a thickness of 1.0 mm or smaller, it is more likely to suffer from scratches compared even with molded articles formed from the same amorphous olefin resin or polycarbonate resin, but having a larger thickness.

As the optical member used for the first and second embodiments, a prism sheet, a light diffusing film, a light reflecting film, a polarizing film, a reflection type polarizing film, a phase difference film, an electromagnetic wave shielding film, and so froth can be used, and it is not particularly limited. Hereafter, the embodiments will be explained by referring to examples using a light diffusing film as the optical member.

The light diffusing film, which is an optical member to be laminated on the diffusing plate or the light conducting plate, has a light diffusing surface for substantially uniformly diffusing lights emitted by the light source and passing through it. Such a light diffusing surface can be realized by preparing fine unevenness on the surface. Although means for realizing such a light diffusing surface is not particularly limited so long as a surface that diffuses lights can be obtained, it can be realized by, for example, providing a light diffusing layer formed from a polymer resin, a light dispersing agent etc. on a base material.

The base material on which the light diffusing layer is formed may be a base material showing high transparency, and for example, highly transparent polymer films formed from one or more kinds of resins selected from polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, vinyl resins, polyethylene resins, polystyrene resins, polypropylene resins, polyamide resins, polyimide resins, melamine resins, phenol resins, silicone resins, fluorocarbon resins, cyclic olefin resins, and so forth are used. In particular, biaxially stretched polyethylene terephthalate films are preferably used, because of superior mechanical strength and dimensional stability thereof. Further, those comprising such a transparent polymer film optionally provided with an adhesion promoting layer or the like are also preferably used. Although thickness of the base material is not particularly limited so long as any problem is not caused concerning handling thereof, it is about 10 to 500 μm, preferably 12 to 350 μm.

The light diffusing layer is formed from a polymer resin and a light dispersing agent. Such a light diffusing layer preferably has a thickness of about 3 to 50 μm.

As the polymer resin for forming the light diffusing layer, a resin showing superior optical transparency can be used, and for example, thermoplastic resins, thermosetting resins and ionizing radiation curable resins such as polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins and silicone resins can be used. Among these, acrylic resins showing superior optical characteristics are preferably used.

As the light dispersing agent for forming the light diffusing layer, inorganic microparticles such as those of silica, clay, talc, calcium carbonate, calcium sulfate, barium sulfate, aluminum silicate, titanium oxide, synthetic zeolite, alumina, and smectite, as well as organic microparticles such as those of styrene resin, urethane resin, benzoguanamine resin, silicone resin, and acrylate resin can be used. Although ratio of the light dispersing agent relative to the binder resin cannot be generally defined since it may vary depending on mean particle diameter of the light dispersing agent used, and thickness of the light diffusing layer etc., it is usually 150% by weight or more, preferably 200% by weight or more, as for the minimum amount, and it is usually 300% by weight or less, preferably 250% by weight or less, as for the maximum amount. With an amount of 150% by weight or more, sufficient light diffusing property can be obtained. With an amount of 300% by weight or less, strength of the resin layer can be maintained.

Although shape of the light dispersing agent is not particularly limited, spherical beads which show superior light diffusing property are preferred. Particle diameter is 2 μm or larger, preferably 5 μm or larger, more preferably 8 μm or larger, as for the minimum diameter, and 25 μm or smaller, preferably 20 μm or smaller, more preferably 15 μm or smaller, as for the maximum diameter. The particle size is defined to be 2 μm or larger, because if magnitude of the unevenness formed on the surface of the light diffusing layer with the light dispersing agent becomes unduly small, light diffusing property can no longer be exhibited, and also defined to be 25 μm or smaller, because if the particle size becomes large, the thickness of the light diffusing layer becomes thick, and it becomes difficult to obtain uniform diffusion.

On the surface of the light diffusing film on which the light diffusing layer is not provided, i.e., the surface on the side to be brought into contact with the diffusing plate or the light conducting plate, a resin layer is formed from a material containing a thermosetting resin and/or a thermoplastic resin, and polyethylene wax particles.

As the thermosetting resin and/or the thermoplastic resin, a resin showing superior optical transparency can be used, and for example, one or more kinds of thermosetting resins and thermoplastic resins such as polyester resins, acrylic resins, acrylic urethane resins, urethane resins, epoxy resins, polycarbonate resins, cellulose resins, acetal resins, polyethylene resins, polystyrene resins, polyamide resins, polyimide resins, melamine resins, phenol resins, and silicone resins can be used. If the resin layer surface becomes unduly hard, the synergistic effect obtained by combinatory use of wax particles mentioned later cannot be obtained, and generation of scratches on the diffusing plate or the light conducting plate cannot be decreased. Therefore, ionizing radiation curable resins are not preferred. Further, if the resin layer surface is unduly soft, adhesion with the diffusing plate or the light conducting plate cannot be prevented, and therefore it is particularly preferable to use a thermosetting resin which provides a suitable hardness of the surface of the resin layer. Specifically, the hardness is preferably not higher than 2H and not lower than HB, particularly preferably around H, in terms of pencil hardness.

As the polyethylene type wax particles, for example, polyethylene wax particles, partially oxidized polyethylene wax particles, ethylene stearate wax particles, and so forth can be used, and those consisting of wax having a high melting point are especially preferred. The melting point is preferably in the range of 100 to 160° C. Since wax having such a melting point provides high heat resistance and high friction resistance, generation of scratches can be continuously prevented. Further, if the resin layer is formed with polyethylene type wax together with the resins mentioned above, polyethylene type wax hardly degrades transparency and light transmission of the resin layer.

Scratches of the diffusing plate or the light conducting plate generated due to contact with an optical member are roughly divided into (1) scratches generated by extraneous dust which entered between the diffusing plate or the light conducting plate and the resin layer, (2) scratches generated due to contact with the resin layer, and (3) scratches generated due to contact with particles which form convexes on the resin layer surface. The optical member of the present invention can prevent generation of scratches due to all the causes mentioned above by defining a mean particle diameter and content of the aforementioned polyethylene type wax particles in the specific ranges, in addition to selecting materials of the aforementioned resin and particles as described above.

Although it is difficult to accurately measure mean particle diameter of polyethylene type wax particles, since they have irregular shapes, those having a mean particle diameter of 4 to 10 μm are used. The mean particle diameter is particularly preferably 5 to 8 μm. If the mean particle diameter is 4 μm or larger, particles buried in the resin layer become fewer so that they can form unevenness, and therefore generation of scratches by extraneous dust can be prevented. Further, if the mean particle diameter is 4 μm or larger, convexes can be formed, therefore contacting area of the resin layer and the diffusing plate or the light conducting plate can be decreased, and generation of scratches by the resin layer itself can be suppressed. Moreover, generation of Newton rings and adhesion of the resin layer and the diffusing plate or the light conducting plate can be prevented.

If the mean particle diameter is 10 μm or smaller, heights of convexes protruding from the resin layer surface do not become unduly high, generation of scratches by particles forming the convexes can be reduced. Further, if the mean particle diameter is 10 μm or smaller, generation of scratches by the resin layer itself due to a small number of the convexes per unit area can be suppressed. Furthermore, generation of Newton rings and adhesion with the diffusing plate or the light conducting plate can be prevented.

Content of the polyethylene type wax particles is 0.20 to 0.50 part by weight, preferably 0.30 to 0.40 part by weight, relative to 100 parts by weight of resin component of the resin layer. If the content of the polyethylene type wax particles is 0.20 part by weight or more, a number of convexes per unit area required to prevent generation of Newton rings and adhesion with the diffusing plate or the light conducting plate can be secured, and generation of scratches by extraneous dust, which are originated from the resin layer exfoliated by cohesive failure of the resin layer due to adhesion, can be prevented. Further, if intervals between convexes become unduly large, the resin layer more frequently contacts with the diffusing plate or the light conducting plate, and thus there arise problems, for example, scratches are generated by the resin layer, and scratches are generated by extraneous dust, which can no longer be caught by concaves. However, these problems can be prevented with the content of the wax particles of 0.20 part by weight or more. Further, if the content is 0.50 part by weight or less, number of convexes per unit area does not unduly increase, and generation of scratches by particles forming the convexes can be suppressed.

The resin layer preferably has a thickness sufficient for containing the polyethylene type wax particles having the aforementioned mean particle diameter at the aforementioned content, and not inviting decrease of brightness. Specifically, it is preferably in the range of 2.0 to 5.0 μm, more preferably in the range of 2.5 to 4.0 μm. With a thickness of the resin layer of 2.0 μm or larger, convexes can be formed by adding the polyethylene type wax particles at a predetermined content, and generation of scratches, generation of Newton rings and adhesion with the diffusing plate or light conducting plate can be prevented. With a thickness of the resin layer of 2.0 μm or larger, convexes and concaves can be formed, therefore extraneous dust can be caught by the concaves, and generation of scratches by extraneous dust can be prevented. Furthermore, even when polyethylene type wax particles having a relatively large particle diameter are added, heights of convexes protruding from the resin layer surface do not become unduly high, and generation of scratches by the convexes can be suppressed.

On the other hand, with a thickness of the resin layer of 5.0 μm or smaller, decrease of light transmission to the light diffusing layer and decrease of brightness at the time of being used as an optical member can be prevented. Furthermore, polyethylene type wax particles can form convexes without being buried in the resin layer, and thus generation of scratches by the resin layer itself can be suppressed. Further, generation of Newton rings and adhesion with the diffusing plate or the light conducting plate can be prevented by forming the convexes. The thickness of the resin layer referred to here means thickness of a portion thereof where the wax particles do not protrude.

Further, the total thickness of the resin layer and the light diffusing layer is preferably in the range of 10 to 20 μm, more preferably 12 to 15 μm, and with such a total thickness, a thin optical member can be obtained.

Configuration of the optical member to be contacted with a diffusing plate or light conducting plate is explained above by exemplifying a light diffusing film. However, by providing such a resin layer as mentioned above on a surface on the side to be brought into contact with a diffusing plate and a light conducting plate, adhesion with a diffusing plate or light conducting plate and generation of scratches can be prevented not only in a light diffusing film, but also in other optical members such as prism sheet, light reflecting film, polarizing film, reflection type polarizing film, phase difference film and electromagnetic wave shielding film.

Hereafter, embodiments of the member of the present invention to be laminated on a molded article (henceforth also referred to simply as “member”) will be explained.

An embodiment of the member of the present invention is shown in FIG. 3. This member 3 is a member to be laminated on a molded article comprising an amorphous olefin resin or a polycarbonate resin, and comprises, as basic elements, a base material 31 and a resin layer 32 formed on one surface of the base material as shown in FIG. 3, and a functional layer 33 for imparting a predetermined function to the base material 31 or the molded article 4 is formed on the other surface of the base material 31 as required. This member 3 is used by being laminated so that the resin layer 32 should contact with the molded article 4. The term “laminate” used in the present invention includes disposing the member so that the member should be superimposed on the molded article, and disposing the member so that the member should contact with the molded article.

The base material 31 is a base material for providing the resin layer 32 and the functional layer 33 thereon. It differs depending on type and use of the member, and may be transparent or opaque, and the material thereof is not also particularly limited. Examples include, for example, the same types of plastic films and glass as those of the base material used for the optical member or light diffusing member mentioned above.

Configuration of the resin layer 32 is the same as that of the resin layer of the optical member of the backlight unit mentioned above, and specifically, it is formed from a material containing a thermosetting resin and/or a thermoplastic resin and polyethylene type wax particles having a mean particle diameter of 4 to 10 μm, and the polyethylene type wax particles are contained in an amount of 0.20 to 0.50 part by weight based on 100 parts by weight of resin component of the resin layer.

Examples of the functional layer 32 include layers having optical characteristics such as light diffusing layer, light reflecting layer, light shielding layer, prism layer and polarizing layer, as well as layers having physical characteristics such as an electromagnetic wave shielding layer. Therefore, examples of the member include a prism sheet, a light diffusing film, a light reflecting film, a polarizing film, a reflection type polarizing film, a phase difference film, an electromagnetic wave shielding film, and so forth.

Although the molded article 4 is not particularly limited, examples include, in addition to the light conducting plate and diffusing plate mentioned above, for example, a light reflecting panel and a case thereof, display panels of electronic equipments, screens, and so forth. Such molded articles comprising an amorphous olefin resin or a polycarbonate resin are objects of the lamination of the member. Although such molded articles show superior characteristics such as superior transparency, impact resistance, heat resistance and dimensional stability, they are relatively soft and easily suffer from scratches.

The member of the present invention has a specific resin layer as a surface to be brought into contact with such a molded article comprising an amorphous olefin resin or a polycarbonate resin, thereby adhesion with the molded article can be prevented, and further generation of scratches can be decreased.

All the layers of the optical member and the member explained above can be formed by blending constituent components of each layer and other components as required, dissolving or dispersing them in an appropriate solvent to prepare a coating solution or dispersion, applying the solution or dispersion by a known method such as roll coating, bar coating, spray coating and air knife coating, drying the coated solution or dispersion, and optionally curing the dried layer by an appropriate curing method.

### EXAMPLES

Hereafter, the present invention will be further explained with reference to examples. The term “part” and the symbol “%” are used on weight basis, unless especially specified.

### 1. Production of Optical Members for Backlight Unit (Light Diffusing Films)

### Example 1

On one surface of a transparent polymer film having a thickness of 188 μm (Lumirror T60, Toray Industries, Inc.), a coating dispersion for light diffusing layer having the following composition was applied by bar coating, and cured by heating to form a light diffusing layer having a thickness of about 15 μm. Further, on the surface of the transparent polymer film opposite to the surface on which the light diffusing layer was formed, a coating dispersion for resin layer having the following composition was applied by bar coating, and cured by heating to form a resin layer having a thickness of about 3 μm, and thereby obtain a light diffusing film of Example 1.

<Coating dispersion for light diffusing layer>

| | |
|---|---|
| Acryl polyol | 10 parts |
| (ACRYDIC A-807, Dainippon Ink & Chemicals, Inc., | |
| solid content: 50%) | |
| Polymethyl methacrylate true spherical particles | 14 parts |
| (Techpolymer MBX-12, Sekisui Plastics Co., Ltd.) | |
| Dilution solvent | 36 parts |
| Curing agent | 2 parts |
| (Takenate D110N, Mitsui Chemicals, Inc., | |
| solid content: 60%) | |

<Coating dispersion for resin layer>

| | | |
|---|---|---|
| Acryl polyol | 10 | parts |
| (ACRYDIC A-807, Dainippon Ink & Chemicals, Inc., | | |
| solid content: 50%) | | |
| Polyethylene type wax particles | 0.022 | part |
| (Ceridust 3620, Clariant Japan K.K., | | |
| mean particle diameter: 8 μm) | | |
| Dilution solvent | 36 | parts |
| Curing agent | 2 | parts |
| (Takenate D110N, Mitsui Chemicals, Inc., | | |
| solid content: 60%) | | |

### Example 2

A light diffusing film of Example 2 was produced in the same manner as that of Example 1 except that the amount of the polyethylene type wax particles in the coating dispersion for resin layer of Example 1 was changed to 0.028 part.

### Example 3

A light diffusing film of Example 3 was produced in the same manner as that of Example 1 except that the amount of the polyethylene type wax particles in the coating dispersion for resin layer of Example 1 was changed to 0.015 part.

### Example 4

A light diffusing film of Example 4 was produced in the same manner as that of Example 1 except that the polyethylene type wax particles in the coating dispersion for resin layer of Example 1 were changed to 0.028 part of Ceridust VP 3610 (Clariant Japan K.K., mean particle diameter: 5 μm).

### Example 5

A light diffusing film of Example 5 was produced in the same manner as that of Example 1 except that the polyethylene type wax particles in the coating dispersion for resin layer of Example 1 were changed to 0.015 part of Shamrock S-394 N1 (Shamrock Technologies, Inc., mean particle diameter: 5 μm).

### Comparative Example 1

A light diffusing film of Comparative Example 1 was produced in the same manner as that of Example 1 except that the amount of the polyethylene type wax particles in the coating dispersion for resin layer of Example 1 was changed to 0.037 part.

### Comparative Example 2

A light diffusing film of Comparative Example 2 was produced in the same manner as that of Example 1 except that the amount of the polyethylene type wax particles in the coating dispersion for resin layer of Example 1 was changed to 0.006 part.

### Comparative Example 3

A light diffusing film of Comparative Example 3 was produced in the same manner as that of Example 1 except that the polyethylene type wax particles in the coating dispersion for resin layer of Example 1 were changed to 0.022 part of Ceridust 130 (Clariant Japan K.K., mean particle diameter: 13 μm).

### Comparative Example 4

A light diffusing film of Comparative Example 4 was produced in the same manner as that of Example 1 except that the polyethylene type wax particles in the coating dispersion for resin layer of Example 1 were changed to 0.022 part of Ceridust 6071 (Clariant Japan K.K., mean particle diameter: 20 μm).

### Comparative Example 5

A light diffusing film of Comparative Example 5 was produced in the same manner as that of Example 1 except that the polyethylene type wax particles in the coating dispersion for resin layer of Example 1 were changed to 0.022 part of silicone resin particles (Tospearl 145, Momentive Performance Materials Inc., mean particle diameter: 5 μm).

### Comparative Example 6

A light diffusing film of Comparative Example 6 was produced in the same manner as that of Example 1 except that the polyethylene type wax particles in the coating dispersion for resin layer of Example 1 were changed to 0.022 part of silicone resin particles (Tospearl 130, Momentive Performance Materials Inc., mean particle diameter: 3 μm).

### Comparative Example 7

A light diffusing film of Comparative Example 7 was produced in the same manner as that of Example 1 except that the polyethylene type wax particles in the coating dispersion for resin layer of Example 1 were changed to 0.022 part of acrylic resin particles (Techpolymer MBX-8, Sekisui Plastics Co., Ltd., mean particle diameter: 8 μm).

### [Evaluation of Properties for Preventing Adhesion to Glass Plate and Newton Rings]

Each of the light diffusing films obtained in Examples 1 to 5 and Comparative Examples 1 to 7 was placed on a glass plate so that the resin layer should contact with the glass plate, the light diffusing film was pressed and rubbed on the light diffusing layer side, and presence or absence of adhesion and Newton ring was observed. The results that there were no adhesion and no Newton ring were indicated with “◯”, and the results that there was adhesion or Newton ring were indicated with “X”. The results are shown in Table 1.

### [Evaluation of Scratch Preventing Property for Amorphous Olefin Resin Plate or Polycarbonate Resin Plate]

Each of the light diffusing films obtained in Examples 1 to 5 and Comparative Examples 1 to 7 and a amorphous olefin resin plate or a polycarbonate resin plate (thickness: 1.0 mm) were set on Suga Abrasion Tester (NUS-ISO-1), and reciprocally moved against each other 10 times at a load of 1.0. N, and then generation of scratches on the amorphous olefin resin plate or the polycarbonate resin plate was observed. The results that scratches were inconspicuous were indicated with “⊚”, the results that scratches were not so conspicuous were indicated with “◯”, and the results that scratches were conspicuous were indicated with “X”. The results are shown in Table 1. Further, the laser microscope photographs of the polycarbonate resin plate surfaces used with the light diffusing films of Example 1, Comparative Examples 1 and 4 for the evaluation of scratch preventing property are shown in FIGS. 4 to 6.

TABLE 1

| | | Amount of wax | | Evaluation of |
|---|---|---|---|---|
| | | particles | Evaluation of | scratch preventing |
| | | relative to | properties for | property for |
| | | 100 parts of | preventing | amorphous olefin |
| | | resin | adhesion to | resin plate or |
| | Mean particle | component in | glass plate and | polycarbonate resin |
| | diameter (μm) | resin layer | Newton rings | plate |
| Example 1 | 8 | 0.35 | ◯ | ⊚ |
| Example 2 | 8 | 0.45 | ◯ | ◯ |
| Example 3 | 8 | 0.24 | ◯ | ◯ |
| Example 4 | 5 | 0.45 | ◯ | ◯ |
| Example 5 | 5 | 0.24 | ◯ | ◯ |
| Comparative | 3 | 0.60 | ◯ | X |
| Example 1 | | | | |
| Comparative | 8 | 0.10 | X | X |
| Example 2 | | | | |
| Comparative | 13 | 0.35 | ◯ | X |
| Example 3 | | | | |
| Comparative | 20 | 0.35 | X | X |
| Example 4 | | | | |
| Comparative | 5 | 0.35 | ◯ | X |
| Example 5 | | | | |
| Comparative | 3 | 0.35 | X | X |
| Example 6 | | | | |
| Comparative | 8 | 0.35 | ◯ | X |
| Example 7 | | | | |

The light diffusing films of Examples 1 to 3 contained polyethylene type wax particles having a mean particle diameter of 8 μm, therefore convexes were appropriately formed on the resin layers, and they showed favorable properties for preventing adhesion to glass plate and Newton rings. In particular, in the light diffusing film of Example 1, convexes and concaves were appropriately formed, and therefore it also showed extremely favorable scratch preventing property for amorphous olefin resin plate or polycarbonate resin plate.

When the light diffusing film of Example 2 was used, scratches on the amorphous olefin resin plate and the polycarbonate resin plate were not so conspicuous, but since it contained the wax particles in a larger amount compared with that of Example 1, number of convexes per unit area became larger, and it could not suppress generation of scratches by particles forming convexes so well compared with the light diffusing film of Example 1.

Also when the light diffusing film of Example 3 was used, scratches on the amorphous olefin resin plate and the polycarbonate resin plate were not so conspicuous, but since it contained the wax particles in a smaller amount compared with that of Example 1, number of convexes per unit area became smaller. Thus, extraneous dust more frequently contacted with the diffusing plate or the light conducting plate, and it could not suppress generation of scratches by extraneous dust so well compared with the light diffusing film of Example 1.

Both the light diffusing films of Examples 4 and 5 contained polyethylene type wax particles having a mean particle diameter of 5 μm, and convexes were appropriately formed on the resin layer. Therefore, they showed favorable properties for preventing adhesion to glass plate and Newton rings. Further, scratches on the amorphous olefin resin plate and the polycarbonate resin plate were not so conspicuous with both of them. However, since the light diffusing film of Examples 4 contained the wax particles in a larger amount compared with that of Example 1, number of convexes per unit area became larger, and it could not suppress generation of scratches by particles forming convexes so well compared with the light diffusing film of Example 1.

The light diffusing film of Example 5 contained the wax particles in a smaller amount compared with that of Example 1, therefore number of convexes per unit area became smaller, extraneous dust more frequently contacted with the diffusing plate or the light conducting plate, and it could not suppress generation of scratches by extraneous dust so much compared with the light diffusing film of Example 1.

The light diffusing film of Comparative Example 1 contained polyethylene type wax particles of the same mean particle diameter as that used in Examples 1 to 3 (8 μm). However, since it contained the wax particles in the resin layer in an amount as large as 0.60 part by weight, number of convexes per unit area unduly increased, and it could not suppress generation of scratches by particles forming convexes, and gave many scratches. Difference in generation of scratches on the polycarbonate resin plate surfaces observed in Example 1 and Comparative Example 1 is also clearly observed in the laser microscope photographs shown in FIGS. 4 and 5.

The light diffusing film of Comparative Example 2 contained polyethylene type wax particles of the same mean particle diameter as that used in Examples 1 to 3 (8 μm). However, since convexes were not appropriately formed on the resin layer, the properties for preventing adhesion to glass plate and Newton rings were poor. Further, it contained the wax particles in an amount as small as 0.10 part by weight, therefore number of convexes per unit area became small, and extraneous dust more frequently contacted with the diffusing plate or the light conducting plate. Thus, it could not suppress generation of scratches by extraneous dust, and deep scratches considered to be generated by extraneous dust were observed in a lager number compared with those observed in the examples.

The light diffusing films of Comparative Examples 3 and 4 contained polyethylene type wax particles at the same content as that of Example 1, but the polyethylene type wax particles had a larger mean particle diameter compared with that used in Example 1. In the light diffusing film of Comparative Example 3, the mean particle diameter was as large as 13 μm, thus height of convex became unduly large, and many thick and deep scratches considered to be generated by the particles forming the convexes were observed.

In the light diffusing film of Comparative Example 4, the mean particle diameter of polyethylene type wax particles was as large as 20 μm, and number of convexes formed by the wax particles was relatively small. Therefore, the properties for preventing adhesion to glass plate and Newton rings were poor. Further, height of convex became unduly large, and many thick and deep scratches considered to be generated by the particles forming the convexes were observed. Difference in generation of scratches on the polycarbonate resin plate surfaces observed in Example 1 and Comparative Example 4 is also clearly observed in the laser microscope photographs shown in FIGS. 4 and 6.

The light diffusing film of Comparative Example 5 contained silicone resin particles having a mean particle diameter of 5 μm instead of the polyethylene type wax particles in the same resin particle amount as that used in Example 1, 0.35 parts by weight, in the resin layer. Since the convexes were formed with the silicone resin particles, the convexes could not be soft convexes, and thus many thick and deep scratches considered to be generated by the particles forming the convexes were observed.

The light diffusing film of Comparative Example 6 contained silicone resin particles having a mean particle diameter of 3 μm instead of the polyethylene type wax particles in the same resin particle amount as that used in Example 1, 0.35 parts by weight, in the resin layer. Since the mean particle diameter was as small as 3 μm, convexes could not be appropriately formed, and the properties for preventing adhesion to glass plate and Newton rings thereof were poor. Further, since convexes and concaves could not be formed, generation of scratches by extraneous dust could not be prevented, and since generation of scratches by the resin layer could not also be prevented, there were many thick and deep scratches considered to be generated by extraneous dust and the resin layer.

The light diffusing film of Comparative Example 7 contained acrylic resin particles having a mean particle diameter of 8 μm instead of the polyethylene type wax particles in the same resin particle amount as that used in Example 1, 0.35 parts by weight, in the resin layer. Since the convexes were formed with the acrylic resin particles, the convexes could not be soft convexes, and thus many thick and deep scratches considered to be generated by the particles forming the convexes were observed.

### 2. Production of Backlight Units

Direct type backlight units were produced by disposing a diffusing plate having a thickness of 1.0 mm and made of an amorphous olefin resin or a polycarbonate resin over a light source, and disposing each of the light diffusing films of Examples 1 to 5 and Comparative Examples 1 to 7 on the diffusing plate so that the resin layer should contact with the diffusing plate.

Further, edge light type backlight units were produced by disposing a light source along one end of a light conducting plate having a thickness of 1.0 mm and made of an amorphous olefin resin or a polycarbonate resin, and disposing each of the light diffusing films of Examples 1 to 5 and Comparative Examples 1 to 7 on the light projection surface of the light conducting plate so that the resin layer should contact with the light conducting plate.

The backlight units using the light diffusing films of Examples 1 to 5 could suppress generation of scratches on the diffusing plate or the light conducting plate, and therefore showed uniform light diffusing property. Further, since the light diffusing film did not adhere to the diffusing plate or the light conducting plate, Newton rings were not generated, and uniform light diffusing property could be obtained.

The backlight units using the light diffusing films of Comparative Example 1 and 3 to 7 could not suppress generation of scratches on the diffusing plate or the light conducting plate. Therefore, scratches were generated due to vibration at the time of transportation, and when the light sources of the backlight units were turned on, scratches were conspicuous, and uniform light diffusing property could not be obtained.

Further, in the backlight units using the light diffusing film of Comparative Example 2, 4 and 6, the light diffusing film adhered to the diffusing plate or the light conducting plate, thus Newton rings were generated, and when the light sources of the backlight units were turned on, the adhered portions became dark, and uniform light diffusing property could not be obtained.

### BRIEF DESCRIPTION OF THE DRAWINGS

FIG. 1 A sectional view of an example of direct type backlight unit.

FIG. 2 A sectional view of an example of edge light type backlight unit.

FIG. 3 A sectional view of an embodiment of the member of present invention.

FIG. 4 A laser microscope photograph of the polycarbonate resin plate surface obtained in the scratch preventing test for the light diffusing film of Example 1.

FIG. 5 A laser microscope photograph of the polycarbonate resin plate surface obtained in the scratch preventing test for the light diffusing film of Comparative Example 1.

FIG. 6 A laser microscope photograph of the polycarbonate resin plate surface obtained in the scratch preventing test for the light diffusing film of Comparative Example 4.

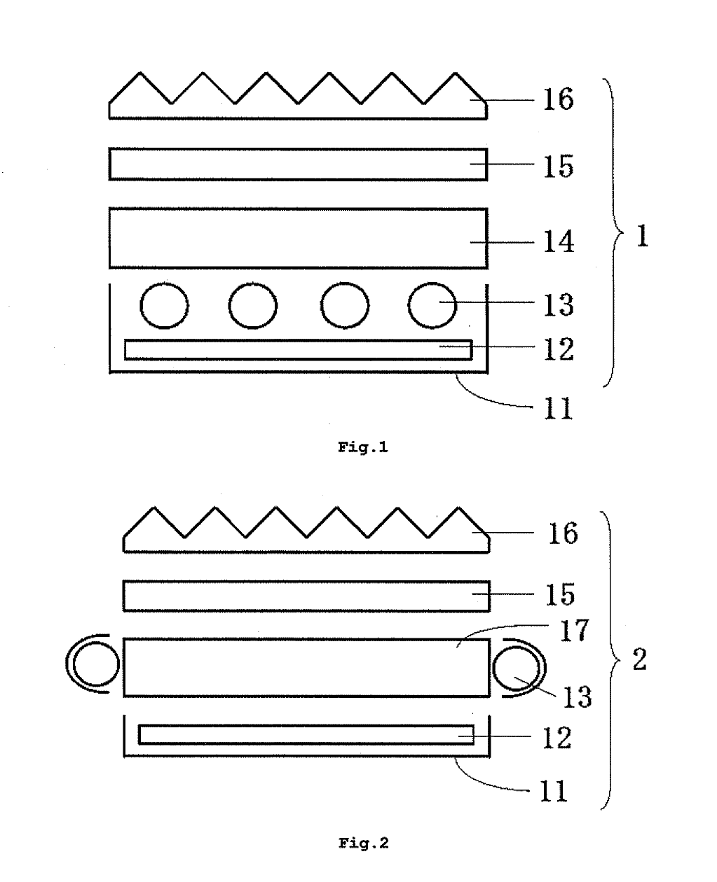

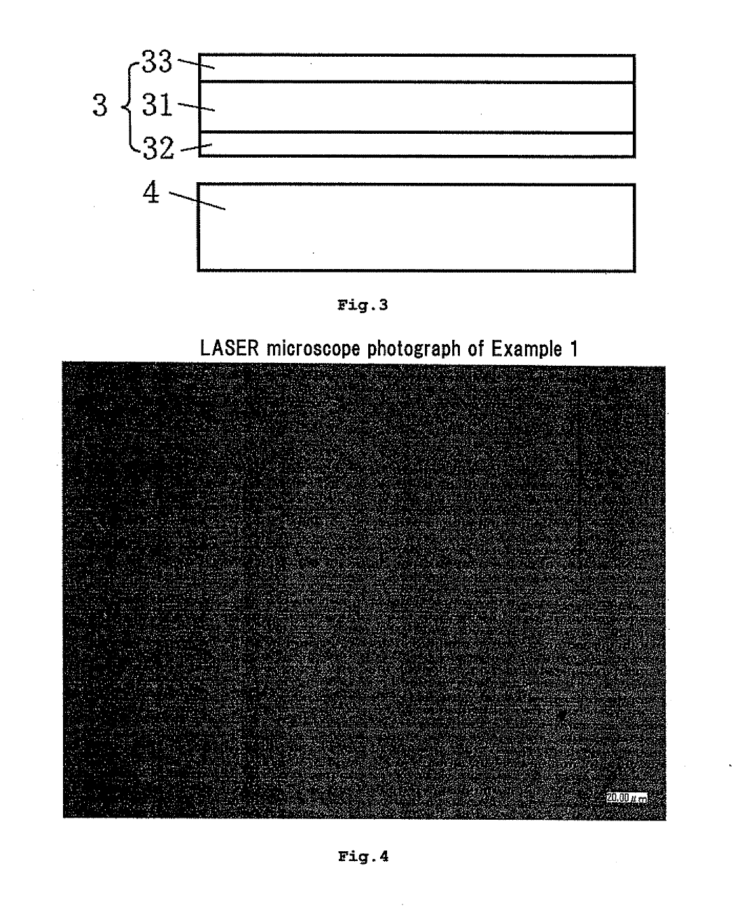

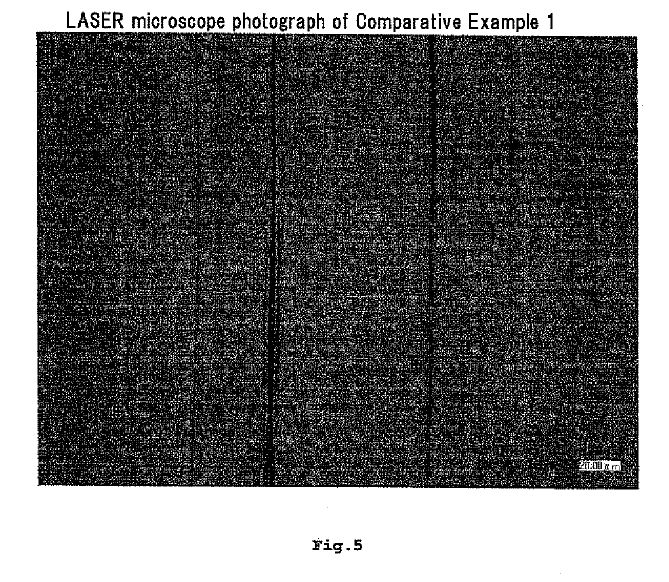

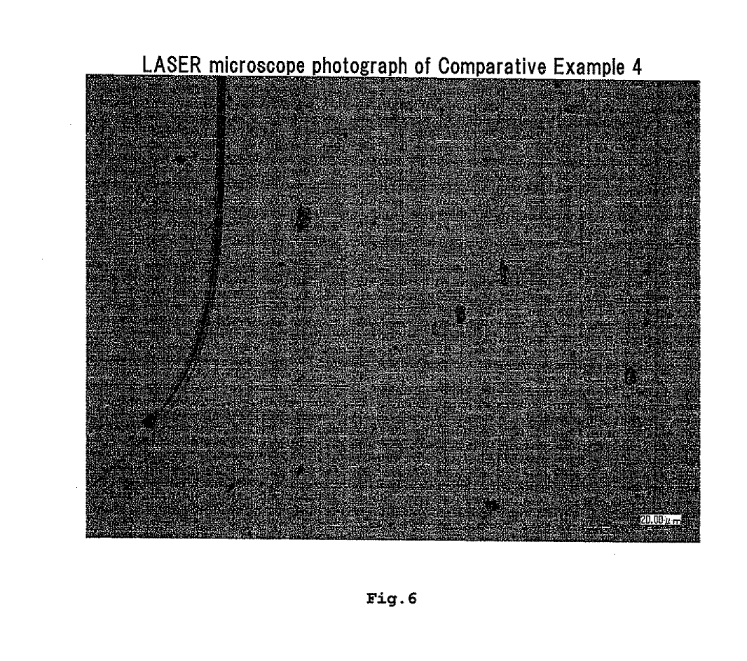

### EXPLANATIONS OF NUMERAL NOTATIONS

1 . . . Direct type backlight unit
2 . . . Edge light type backlight unit
3 . . . Member (member for being laminated on molded article)
4 . . . Molded article
11 . . . Chassis
12 . . . Light reflecting film
13 . . . Light source
14 . . . Diffusing panel
15 . . . Optical member (light diffusing film)
16 . . . Prism sheet
17 . . . Light conducting panel
31 . . . Base material
32 . . . Resin layer
33 . . . Functional layer

1. A backlight unit comprising a light source, an optical element for conducting or diffusing light disposed close to the light source, and an optical member disposed on the optical element, wherein:
the optical member has a resin layer formed from a material containing a thermosetting resin and/or a thermoplastic resin, and polyethylene wax particles on the side to be contacted with the optical element, the polyethylene wax particles have a mean particle diameter of 4 to 10 μm, and the content of the polyethylene wax particles is 0.20 to 0.50 part by weight based on 100 parts by weight of resin component of the resin layer.

2. The backlight unit according to claim 1, wherein:
material of the optical element is an amorphous olefin resin or a polycarbonate resin.

3. The backlight unit according to claim 2, wherein:
the resin layer have a thickness not smaller than 2.0 μm and not larger than 5.0 μm.

4. The backlight unit according to claim 1, wherein:
the resin layer has a surface hardness not lower than HB and not higher than 2H.

5. The backlight unit according to claim 1, wherein:
the optical element is a diffusing plate disposed over the light source, and the backlight unit is a direct type backlight unit.

6. The backlight unit according to claim 1, wherein:
the optical element is a light conducting plate, the light source is disposed along at least one end of the light conducting plate, and the backlight unit is an edge light type backlight unit.

7. The backlight unit according to claim 1, wherein:
the optical member has a functional layer for giving an optical characteristic on the side opposite to the side on which the resin layer is formed.

8. A member to be laminated on a molded article comprising an amorphous olefin resin or a polycarbonate resin, wherein the member has a resin layer formed from a material containing a thermosetting resin and/or a thermoplastic resin, and polyethylene wax particles having a mean particle diameter of 4 to 10 μm on the side to be contacted with the molded article, and the content of the polyethylene wax particles is 0.20 to 0.50 part by weight based on 100 parts by weight of resin component of the resin layer.

9. The member according to claim 8, which has a functional layer.

10. The member according to claim 8, which is an optical member selected from a prism sheet, a light diffusing film, a light reflecting film, a polarizing film, a reflection type polarizing film, a phase difference film, and an electromagnetic wave shielding film.

11. The member according to claim 9, wherein the functional layer is a light diffusing layer.

12. The backlight unit according to claim 1, wherein:
the resin layer have a thickness not smaller than 2.0 μm and not larger than 5.0 μm.
